(19) United States
(12) Patent Application Publication
(10) Pub. No.: US 2025/0384075 A1
(43) Pub. Date: Dec. 18, 2025

(54) DATA ANALYSIS SYSTEM AND METHOD

(71) Applicant: Calabrio, Inc., Minneapolis, MN (US)

(72) Inventors: Alexander Kvamme, Minneapolis, MN (US); John Doig, III, Minneapolis, MN (US)

(21) Appl. No.: 19/237,939

(22) Filed: Jun. 13, 2025

Related U.S. Application Data
(60) Provisional application No. 63/660,068, filed on Jun. 14, 2024.

(51) Int. Cl. G06F 16/34; G06F 21/62

(52) U.S. Cl. CPC G06F 16/345; G06F 21/6254

(57) ABSTRACT

data analysis method can include: receiving a set of data records from an entity; determining a set of summaries for each data record S200; determining a set of signals based on a batch of summaries across the set of data records S300; and determining a hypersignal based on the set of signals S400. The method can optionally include: determining an analysis based on the set of signals or hypersignals for the entity; and/or generating recommendations for the entity. The method functions to extract population-level signals (e.g., insights) from the content of each data record within large corpuses of detailed data. In variants, the method can extract the signals in real- or near-real time.

The present disclosure claims the benefit of U.S. Provisional Patent Application Ser. No. 63/660,068, filed Jun. 14, 2024, titled DATA ANALYSIS SYSTEM AND METHOD, the entire disclosure of which is expressly incorporated by reference herein.

### TECHNICAL FIELD

This invention relates generally to the data analytics field, and more specifically to a new and useful system and method for insight discovery and analysis in the data analytics field.

### BACKGROUND

Many entities want to extract detailed analyses from their customer data, such as customer conversations, since these analyses can lead to customer intelligence, technical issue discovery, and other actionable insights. However, to do so, each data record must be both analyzed at a highly detailed level, down to the individual word, and summarized across the entire dataset, since a single signal may not be indicative of a trend. While this per-record and population-level analysis would theoretically be possible if the records or overall data corpus was small, this is untenable in reality—each record (e.g., conversation) can have thousands of tokens, and the corpus of data can include thousands or millions of records. This makes real-time analyses extremely difficult, if not impossible. Furthermore, conventional methods can only detect predetermined, known signals in the data corpus, and are unable to discover de novo insights or issues.

Thus, there is a need in the data analytics field to create a new and useful system and method for insight discovery and analysis.

### SUMMARY

Aspects of the present disclosure relate to systems and methods for performing data analysis. For example, a method can include: receiving a set of customer conversations from an entity (e.g., from a shared time window); and determining a set of summaries for each conversation using a summary agent and a set of signal class prompts (“insight stream prompts”) for a set of signal classes (“insight streams”), wherein the summary agent generates one or more summaries for each signal class, based on the respective signal class prompt. The summaries for the same signal class can then be batched across the set of conversations. A set of signals (“reflections”, “subthemes”, “tags”) can then be extracted from summary batch by a record agent (e.g., “reflection agent”, for the respective signal class). The record agent may be a generative model, but otherwise configured to automatically discover signals from the summary batch.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE FIGURES

FIG. 1 is a schematic representation of a variant of the data analysis method.

FIG. 2 is a schematic representation of a variant of the data analysis system.

FIG. 3 is a schematic representation of a variant of the data analysis system, depicting multiple signal classes.

FIG. 4 is an illustrative example of data records, summaries, and associated insights.

FIG. 5 is an illustrative example of data records and associated insights.

FIG. 6 is an illustrative example of hypersignals, related signals, and timeseries analyses.

FIG. 7 is an illustrative example of a summary and the associated insights.

FIG. 8 is an illustrative example of hypersignals, related signals, and timeseries analyses.

FIG. 9 is an illustrative example of a timeseries analysis.

FIG. 10 is an illustrative example of a custom signal prompt.

FIG. 11 illustrates a simplified block diagram of a device with which aspects of the present disclosure may be practiced in accordance with aspects of the present disclosure.

### DETAILED DESCRIPTION

The following description of the embodiments of the invention is not intended to limit the invention to these embodiments, but rather to enable any person skilled in the art to make and use this invention.

### 1. Overview

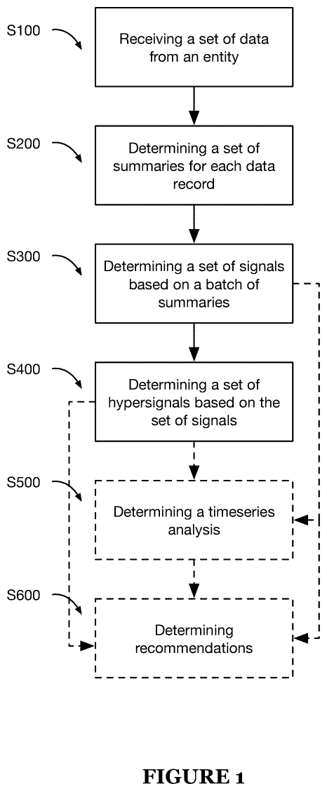

As shown in FIG. 1, in variants, the data analysis method can include: receiving a set of data records from an entity S100; determining a set of summaries for each data record S200; determining a set of signals based on a batch of summaries across the set of data records S300; and determining a hypersignal based on the set of signals S400. The method can optionally include: determining an analysis based on the set of signals or hypersignals for the entity; and/or generating recommendations for the entity. The method functions to extract population-level signals (e.g., insights) from the content of each data record within large corpuses of detailed data. In variants, the method can extract the signals in real- or near-real time.

In an illustrative example, the method can include: receiving a set of customer conversations from an entity (e.g., from a shared time window); and determining a set of summaries for each conversation using a summary agent and a set of signal class prompts (“insight stream prompts”) for a set of signal classes (“insight streams”), wherein the summary agent generates one or more summaries for each signal class, based on the respective signal class prompt. The summaries for the same signal class can then be batched across the set of conversations. A set of signals (“reflections”, “subthemes”, “tags”) can then be extracted from summary batch by a record agent (e.g., “reflection agent”, for the respective signal class). The record agent may be a generative model, but otherwise configured to automatically discover signals from the summary batch.

The signal sets (“reflections”) generated by one or more record agents can then be provided to a theme agent, wherein the record agents and the theme agent can be associated with the same signal class. The theme agent can: extract hypersignals (“themes”) from the one or more signal sets, consolidate the signal sets (e.g., remove duplicate signals, etc.), summarize the signal sets, detect emerging patterns within the signal sets (e.g., relative to historical signals for the signal class and/or output by the record agent), detect anomalies from the signal sets (e.g., deviation from a baseline signal occurrence), and/or otherwise analyze the signal sets. In variants, the themes, underlying signals (“reflections”, “subthemes”), and/or other insights can be displayed to the user alongside statistics for the conversations that generated the signals (e.g., number of conversations, metadata, etc.). The method can be iteratively repeated to generate a timeseries of signals, themes, and/or summaries (e.g., for a signal class). In variants, these timeseries of extracted signals and/or themes can be further consolidated into higher-level analyses by context agents, or otherwise used. However, themes, signals, and/or other insights can be otherwise extracted from the data.

### 2. Technical Advantages

Variants of the technology can confer technical advantages over conventional systems and methods.

First, variants of the technology enable automatic discovery of unknown insights from the dataset by leveraging generative models, such as LLMs or foundation models. For example, unlike conventional methods can only detect a set of predetermined signals (e.g., using discriminative models), this technology can use generative models to extract new, unknown, de novo signals (e.g., reflections, subthemes) from the dataset. In another example, the technology can use generative models to generate new themes from a set of signals, which can enable new theme discovery while reducing noise and increasing comprehension of the overall dataset. In variants, the technology can be used without: manually specifying keywords or tags of interest, manually tagging data records, manually creating categories, and/or other manual insight infrastructure creation. This is helpful, since entities cannot proactively look for hidden insights that they are unaware of.

Second, variants of the technology can enable more accurate and sensitive insight extraction. For example, instead of using a generalized record agent and theme agent that may not be sensitive enough to identify all signals of interest at an emergent stage, variants of the technology can use record agents and theme agents that are trained or tuned to extract insights for a given signal class (“insight stream”) from a set of data records (or summaries thereof). This specialization can enable the agents to be more sensitive to signals and themes that are relevant to the signal class, which, in turn, can result in more accurate and nuanced detections. In another example, instead of using a single generalized summary of a data record, the technology can use a different summary of the same data record for each signal class, which can further increase the signal and/or theme extraction accuracy. For example, the signal class-specific summary can include information that is useful for a record agent of the signal class, but is not relevant, misleading, or confounding for a record agent of a different signal class.

Third, variants of the technology can enable concurrent analysis across a plurality of large data records in real- or near-real time by summarizing the data records to reduce the number of tokens that need to be analyzed by the record agent and/or theme agents. Since generative models suffer from token limits, these limitations can be extremely problematic when multiple conversations must be analyzed together to provide population-level context, but each conversation includes thousands of tokens (e.g., words, word fragments, punctuation, etc.); the aggregate number of tokens that need to be analyzed far surpasses the generative models' token limits. While newer models could theoretically ingest larger volumes of tokens, these newer models can suffer from latency issues (e.g., infer results slowly), and are therefore less suitable for real-time analyses that need to detect emergent trends and signals quickly. Conventional methods of feeding the model different conversation chunks causes the model to lose the context of each chunk within the conversation; additional metadata and postprocessing is oftentimes necessary to rejoin any analyses extracted from the chunks, which can increase the amount of data that needs to be tracked, consume more processing power, slow down the analyses, and oftentimes results in lower-accuracy analyses. By summarizing the data records, then feeding the summaries to the generative models, this technology can preserve the information from the data records while keeping said information in context.

Fourth, variants of the technology can enable an insight to be traced down to the originating data record. For example, a data record's identifier can be associated with the summaries generated from the data record, the signals generated from the summaries, and the hypersignals (“theme”) generated from the signals. This can enable an entity to easily identify and review the data records that resulted in a signal or hypersignal of interest.

Fifth, variants of the technology can enable scalable, real-time processing of large volumes of data parallelizing the summarization and analyses. The technology can further scale the analyses by concurrently creating multiple summaries of the same data record for different signal classes, such that each data record can be contemporaneously analyzed along multiple different dimensions.

However, further advantages can be provided by the system and method disclosed herein.

### 3. System

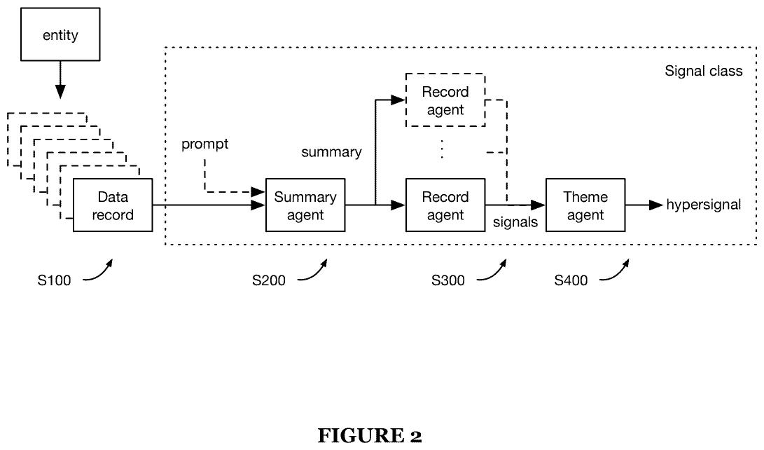

As shown in FIG. 2, in variants, the method can be performed using a system including: a set of data records, a summary agent, one or more record agents, and one or more theme agents. The system can optionally include one or more context agents. The system can function to extract insights (e.g., signals, hypersignals, etc.) from the set of data records. In examples, the system can extract a timeseries of insights from the set of data records for one or more signal classes (“insight streams”) using summaries, record agents, and theme agents that are specific to the signal classes.

The system can be used by one or more entities, which function to provide the data record sets. Examples of entities can include, but are not limited to: businesses, corporations, services, call centers, and/or other entities. Additionally or alternatively, the entity can be or include one or more datasources, such as databases, sensor sets (e.g., cameras, etc.), and/or other datasources.

In variants, the entities can use the system to detect predetermined insights, new insights, emergent trends, and/or other high-level analyses from the data records. Examples of insights that can be detected can include: supply chain issues, operations issues, fulfillment issues, product quality issues, customer intent (e.g., reason why a customer has expressed a frustration, concern, or desire), customer sentiment (e.g., emotion valence), customer churn, upgrade opportunities, agent analyses (e.g., agent sentiment, procedural compliance, etc.), and/or other insights.

Insights can include, but are not limited to: signals, hypersignals, timeseries analyses, and/or other analyses.

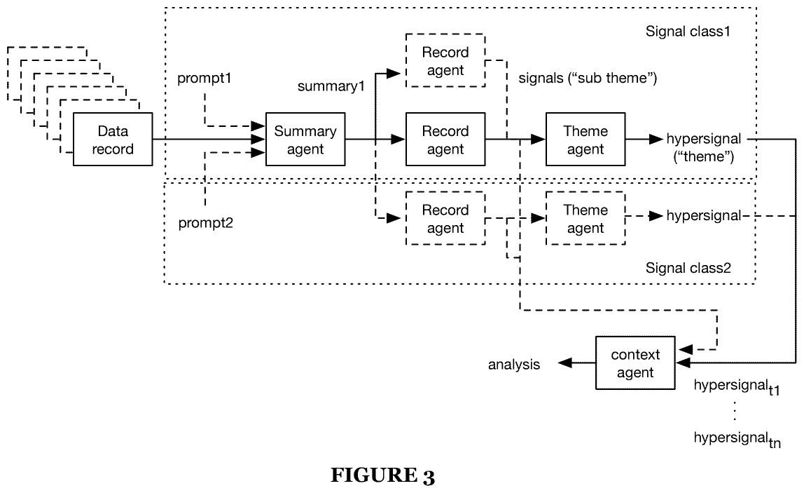

An insight is associated with a signal class (“insight stream”), which functions as an overall class that encompasses conceptually related signals, hypersignals, timeseries analyses, and/or other insights. Examples of signal classes can include, but are not limited to: supply chain, operations, fulfillment, product quality, customer churn, returns, product reception, customer conversion, cancellations, and/or other signal classes. Each signal class can be associated with one or more: prompts for the summary agent, record agents, theme agents, context agents, and/or other agents. In an example, a signal class can be associated with a plurality of prompts, a plurality of record agents, a single theme agent, and a single context agent. A system can include multiple signal classes (e.g., example shown in FIG. 3). However, a signal class can be associated with any number of prompts and agents.

The signal class (“insight stream”) may be predetermined, but can alternatively be dynamically determined during runtime (e.g., during inference; from the set of extracted signals). In an example, the signal class is predetermined, and associated with a set of predetermined (e.g., pretrained, tuned, prompt-engineered, etc.): prompts, record agents, theme agent(s), and context agent(s). In this example, the signal class can optionally be associated with a set of predetermined signals, wherein the set of signals extracted by the record agents can include, but not be limited to, the set of predetermined signals. However, the signal class can be otherwise configured.

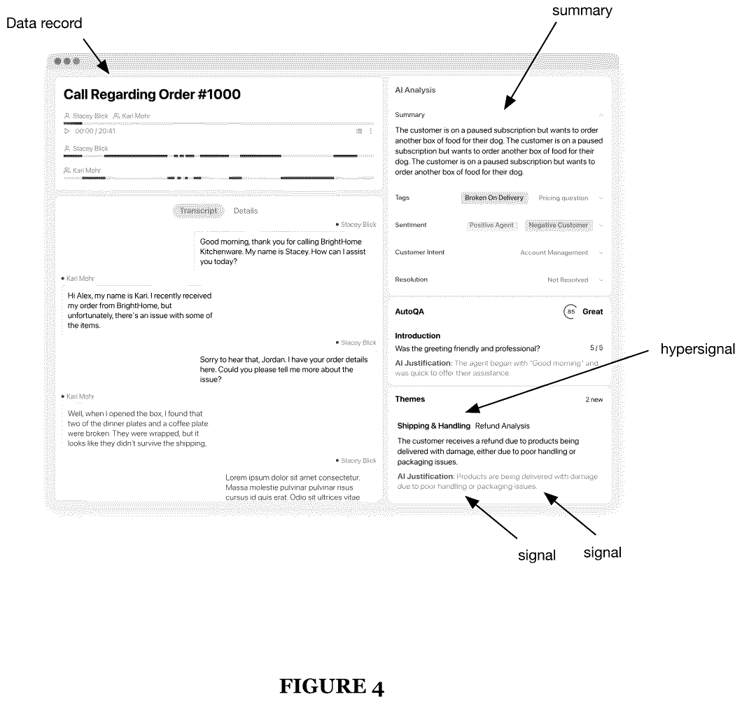

Signals (“subtheme”, “reflection”, etc.) function as a lower-level insights that are extracted from multiple data records from a common time window (e.g., example shown in FIG. 4). The signals that are extracted from the dataset can include, but are not limited to: predetermined signals (e.g., extracted using a model trained or prompted to detect said signal); generated signals (e.g., extracted using a generative model, wherein the generative model is not specifically prompted to detect said signal); and/or other signals. Illustrative examples of signals for a churn analysis signal class can include, but are not limited to: “cheaper price for the same service”, “more reliable service provided by a competitor”, and “promotion for more bandwidth”.

Hypersignals (“theme”) function as higher-level insights of the signals for a given time window. The hypersignals can, for example, be: predetermined (e.g., manually specified); be the signals themselves (e.g., be a deduplication or single instance of a unique signal within the signal set); be generated hypersignals (e.g., wherein a generative model generates new terms to summarize the signals; example shown in FIG. 4); and/or be otherwise constructed. Illustrative examples of hypersignals for a churn analysis signal class can include: “competitors”, “product defects”, and “price”.

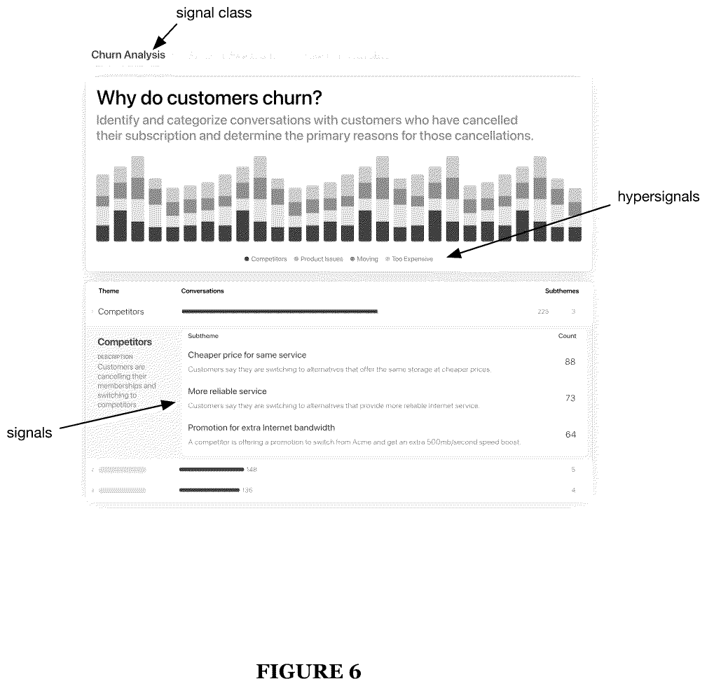

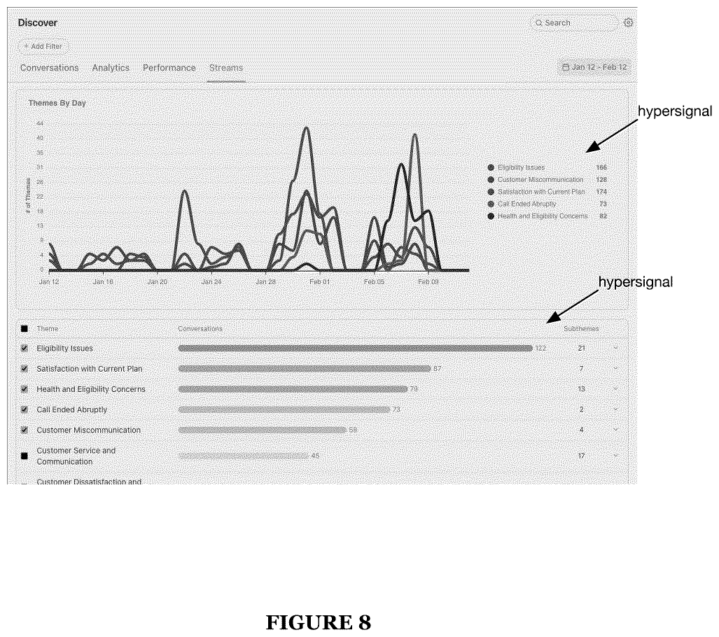

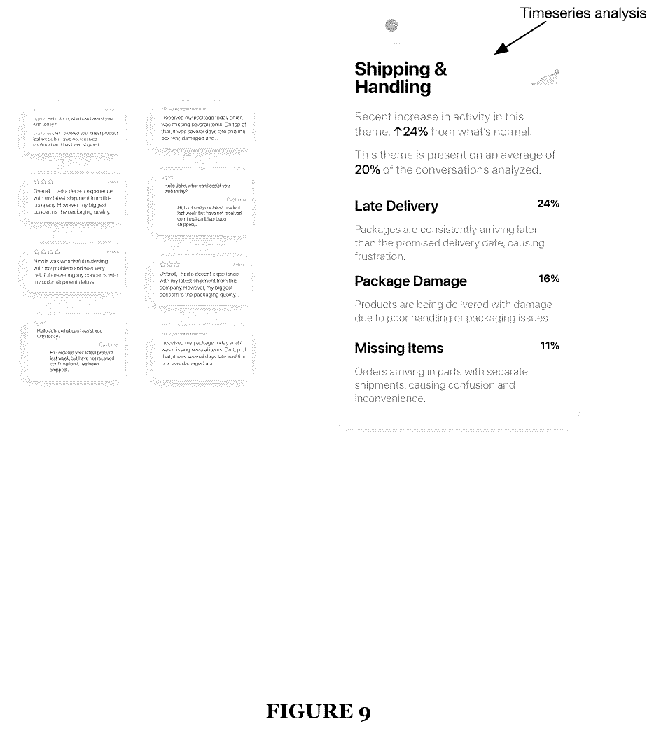

Timeseries analyses function to provide dataset insights over time. The timeseries analyses can be determined from a timeseries of signals, hypersignals, and/or other insights. The insights can be from the same or different signal class. The timeseries analyses can be statistical measures (e.g., averages, trendlines, etc.), human readable summaries (e.g., “return rate dropped in August”), and/or otherwise constructed. Examples are shown in FIG. 6, FIG. 8, and FIG. 9.

However, the system can generate any other suitable analysis.

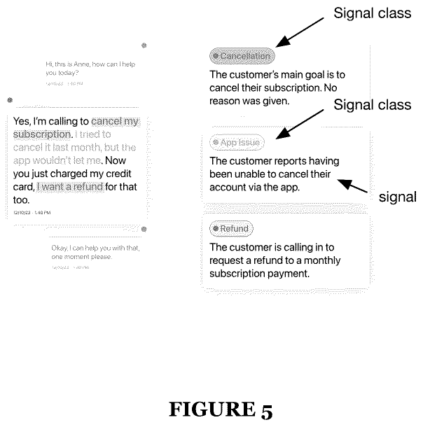

The set of data records function as the raw data from which insights can be extracted. The data records are received from the entity but can be otherwise obtained. Examples of data records can include, but are not limited to: customer conversations, machine state streams (e.g., event logs, etc.), and/or other data records. Examples of data record types can include: audio records (e.g., phone calls), text records (e.g., email, chat, SMS, MMS, customer reviews, etc.; examples shown in FIG. 4 and FIG. 5), scores (e.g., customer satisfaction scores, ratings, etc.), video records (e.g., customer reviews, etc.), 3D records (e.g., depth recordings, etc.), extended reality recordings, and/or be in any other suitable format or domain. The data record can be stored, received, ingested, and/or otherwise used in: the data record's raw format, a json representation (e.g., transcription, description, etc.), a tokenized representation, an encoding or embedding (e.g., embedded into a latent space, such as a semantic meaning space, a context space, a sentiment space, etc.; a feature vector; etc.), in chunks (e.g., split by token number, split semantically, split by message, etc.), and/or otherwise represented. The data record can be preprocessed to remove personally identifiable information (PII), filler words, to identify speakers, or otherwise processed; alternatively, the data record can be used in an unprocessed form. A data record spans a single conversation, but can additionally or alternatively span a single message within the conversation, span multiple conversations, and/or be otherwise defined. For example, a conversation can be defined by: a start event and a stop event (e.g., opening a ticket, closing a ticket, etc.); duration (e.g., threshold amount of time since last message); and/or otherwise defined. The data records can be obtained from: an entity database, a third party (e.g., social media), and/or any other suitable data source. The data records can be used to generate one or more: summaries, signals, hypersignals, and/or other insights. In an illustrative example, a data record is used to generate multiple summaries (e.g., one or more for each signal class); multiple signals (e.g., from each of the summaries); one or more hypersignals (e.g., from aggregating signals related by signal class); and/or one or more timeseries analyses (e.g., from aggregating the hypersignals over time).

The summary agent functions to generate one or more summaries of a data record. In variants, the summary agent ingests a data record (or representation thereof) and a prompt, and outputs a summary of the data record. In an example, the summary agent ingests the data record and a prompt specific to a signal class (signal class prompt), and outputs a data record summary specific to the signal class. The summary agent is generic and shared across all signal classes, but can alternatively be specific to a signal class or otherwise constructed. In the latter variant, data records can be passed to multiple signal class-specific summary agents to generate summaries of the data record for each signal class.

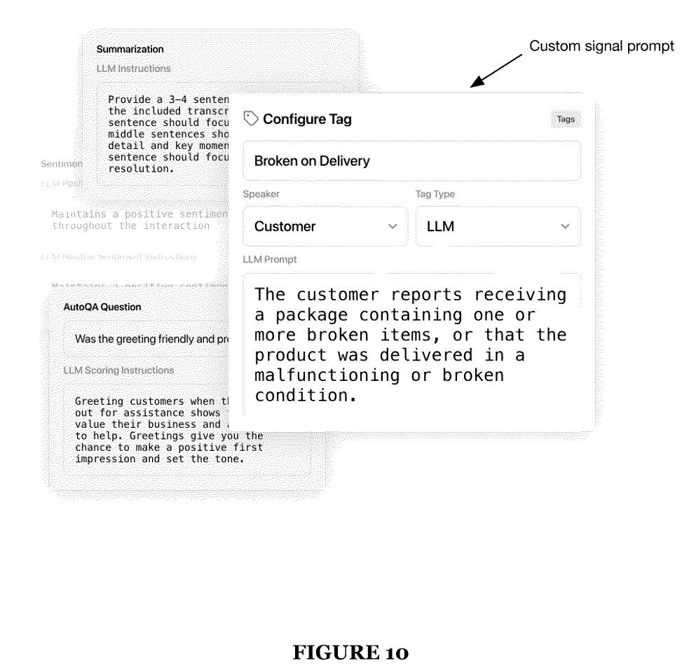

The signal class prompt can include, but is not limited to: natural language, embeddings, tokens, and/or be otherwise represented. The prompt can be a standardized prompt (e.g., for a standardized signal class), a custom prompt received from the entity (e.g., example shown in FIG. 10), and/or otherwise determined. In examples, the prompt is specific to the signal class but can alternatively be a general prompt. An example signal class prompt for a customer sentiment prompt can include “Summarize the customer sentiment, the reason for the customer sentiment, the facts of the situation, and the customer representative's solution.” Other example prompts include: “Provide a 3-4 sentence summary of the included transcript. The first sentence should focus on the overall customer intent. The middle sentences should describe the factual details, customer statements, and key moments indicating the customer intent in the conversation. The last sentence should focus on the final resolution.” In examples, the signal class prompt is static (e.g., does not change), but can alternatively be dynamic (e.g., determined based on historical data records, historical signals, etc.; learned; updated to extract higher-relevancy features; etc.), be manually specified (e.g., by the entity), and/or otherwise determined. However, other prompts can be used, and the prompt can be otherwise constructed.

The summary agent may be generic and shared across different signal classes, but can alternatively be specific to a signal class. The summary agent may be generic and shared across different entities, but can alternatively be specific to an entity. In examples, the system includes a single summary agent (e.g., multiple instances of the same summary agent executing in parallel), but can alternatively include multiple summary agents (e.g., for different signal classes, entities, etc.).

The summary agent may be a generative model, such as a large language model, but can additionally or alternatively be a foundation model (e.g., spanning multiple domains), a Q&A model (e.g., BERT), chain of thought model, a RAG model, utilize another neural network architecture (e.g., DNN, CNN, transformers, deep belief networks, RNNs, etc.), and/or have any other suitable architecture. The summary agent can be finetuned (e.g., using a set of prompts with target summaries, using user labels on whether the summary was correct or not), used without finetuning, or otherwise trained.

In a first variant, the summary agent includes an LLM that is prompted to summarize the content of the data record based on a signal class-specific prompt.

In a second variant, the summary agent includes an embedding or encoding model that is configured to (e.g., trained to) generate one or more embeddings from the data record. The embeddings can represent (e.g., be in the latent space of): tokens (e.g., words within the data record), semantics, concepts, sentiment, and/or other information.

However, the summary agent can be otherwise constructed.

The record agent functions to extract signals for a set of data records. In examples, the system includes multiple record agents but, alternatively, can include a single record agent. Each signal class can be associated with one or more record agents. A record agent is associated with a single signal class but can alternatively be associated with multiple signal classes.

In variants, the record agent ingests a set of summaries and a signal-extraction prompt, and outputs a set of signals (e.g., signal values).

The record agent extracts signals from a set of summaries, but can alternatively extract signals from a single summary, from the data record, and/or from any other suitable set of information. The set of summaries are derived from multiple data records but can alternatively be derived from a single data record. The set of summaries ingested by the record agent are determined responsive to a prompt for a signal class associated with the record agent but can alternatively be determined responsive to a prompt for another signal class, a generic prompt, or other prompt. The set of summaries can be determined using the same prompt or be determined using different prompts. The set of data records may be from the same time window and from the same entity, but can additionally or alternatively share or not share other attributes (e.g., be from different time windows, be from different entities, etc.). In an example, multiple summaries from multiple data records (e.g., from the same time window) are aggregated into a summary batch, wherein the record agent determines the signals from the summary batch.

The signal extraction prompt guides signal extraction. In an example, the signal-extraction prompt can include “Generate tags for potential issues detected in the transcript”. In another example, the signal-extraction prompt can include: “Output a “broken on delivery” tag if the customer reports receiving a package containing one or more broken items, or that the product was delivered in a malfunctioning or broken condition”. The signal extraction prompt can be specific to the signal class, specific to the record agent, specific to the entity, be manually determined, and/or otherwise specific or generic. Alternatively, no signal extraction prompt can be used.

In examples, the set of signals (“subthemes”) output by the record agent is in natural language (e.g., human readable), examples shown in FIG. 4 and FIG. 6, but can alternatively be an embedding (e.g., in a latent space, in a subtheme space, in a latent space specific to the signal class, etc.) or be otherwise represented. The signals can be generated, detected (e.g., wherein the signals are predetermined by a user or during training, etc.), or otherwise determined.

The record agent is a generative model in some examples, such as a large language model, but can additionally or alternatively be a foundation model (e.g., spanning multiple domains), a Q&A model (e.g., BERT), chain of thought model, have another neural network architecture (e.g., DNN, CNN, transformers, deep belief networks, RNNs, etc.), a classifier (e.g., detect whether one or more of a predetermined set of signals appears within the data record, using a set of classification heads, etc.), and/or have any other suitable architecture. The record agent can be finetuned (e.g., using a set of prompts with target summaries, using manual tags on whether the signals were correct or not), used without finetuning, or otherwise trained. In variants, the record agent can have a set of predetermined model parameter values (e.g., temperature, top k, top p, frequency penalty, maximum token response, presence penalty, etc.), which can be selected based on the amount of de novo discovery that is desired.

In a first variant, the record agent is prompted to determine a set of signals (“themes”, “subthemes”), given a set of data record summaries generated for a prompt associated with the same signal class as the record agent.

In a second variant, the record agent generates one or more embeddings for each summary in one or more shared latent spaces (e.g., a semantic space, etc.); determines clusters of the embeddings within the latent spaces (e.g., based on a distance metric, such as a cosine similarity, etc.); and generates a description for each cluster (e.g., based on the embeddings within each cluster). The description can be generated from: the embeddings themselves (e.g., the embeddings or an aggregated embedding, such as a median embedding, is decoded into a natural language space); from the source summaries (e.g., the record model is instructed to generate descriptions of similarities between the summaries); and/or otherwise determined.

The theme agents function to aggregate, filter, and otherwise sift through the signals generated by the record agents. In an example, the theme agent can deduplicate the same signal detected by different record agents. In a second example, the theme agent can aggregate similar signals (e.g., aggregate conceptually similar signals, such as “more attractive designs” and “cuter designs”, into a single signal).

The theme agents can also generate higher-level summaries of the signals (“hypersignal”). For example, the theme agent can determine that multiple signals are all related to customer attrition and generate a “moved to competitor” hypersignal.

The theme agent can also determine signal weights, based on the respective signal's: occurrence frequency within the signal set, urgency, signal history, and/or other information.

The system, in examples, includes multiple theme agents, but alternatively can include a single theme agent. A signal class is associated with a single theme agent but can alternatively be associated with multiple theme agents. A theme agent is associated with a single signal class but can alternatively be associated with multiple signal classes. A theme agent may also be associated with multiple record agents but can alternatively be associated with a single record agent. The record agents are, in examples, associated with the same shared signal class as the theme agent, but can alternatively be associated with other signal classes. In examples, a record agent is associated with a single theme agent but can alternatively be associated with multiple theme agents.

In variants, the theme agent ingests a set of signals and a theme-extraction prompt, and outputs a set of hypersignals (“themes”).

The set of signals are from one or more record agents and, in examples, are associated with the same signal class as the theme agent but can alternatively be from record agents unassociated with the signal class, or from other record agents. In one example, the set of signals are from a single time window (e.g., the same time window used to determine the batch of summaries for the record agent) but can alternatively be from multiple time windows. Alternatively, the theme agent can determine hypersignals from the data records, summaries, or any other representation thereof.

The theme-extraction prompt guides hypersignal extraction. In examples, the theme-extraction prompt can include “What are the top 10 themes within this set of themes, and generate a category that encompasses those top 10 themes”, “summarize the top reasons why the customer has moved to a competitor”, or other prompts. The theme-extraction prompt can be specific to the signal class, specific to the record agent, specific to the entity, be manually determined, and/or otherwise specific or generic.

The set of hypersignals (“themes”) output by the theme agent maybe be a natural language (e.g., human readable) output, but can alternatively or additionally be an embedding (e.g., in a latent space, in a subtheme space, in a latent space specific to the signal class, etc.) or be otherwise represented. The hypersignals can be generated, detected (e.g., wherein the signals are predetermined by a user or during training, etc.), or otherwise determined.

The theme agent can be: a generative model (e.g., LLM, etc.), a foundation model (e.g., spanning multiple domains), a Q&A model (e.g., BERT), chain of thought model, have another neural network architecture (e.g., DNN, CNN, transformers, deep belief networks, RNNs, etc.), a classifier (e.g., detect whether one or more of a predetermined set of hypersignals appears within the data record, using a set of classification heads, etc.), a set of heuristics (e.g., extract signals that appear in the signal set with more than a threshold frequency, heavily weight or identify signals that deviate from a baseline historical frequency by a threshold value, etc.), a distance model or decoder (e.g., that generates tags or summaries of signals embedded in a shared latent space), and/or have any other suitable architecture. The theme agent has a memory of signals and/or hypersignals from prior timesteps but can alternatively lack a memory. The theme agent can be finetuned (e.g., using a set of prompts with target summaries, using manual tags on whether the hypersignals were correct or not), used without finetuning, or otherwise trained. In variants, the theme agent can have a set of predetermined model parameter values (e.g., temperature, top k, top p, frequency penalty, maximum token response, presence penalty, etc.), which can be selected based on the amount of de novo discovery that is desired.

In a first variant, the theme agent includes a generative model that generates a set of hypersignals (“themes”), given the set of signals (“subthemes”) and a prompt.

In a second variant, the theme agent includes a classifier that determines a set of classifications (e.g., hypersignals) given the set of signals. In this variant, the set of signals can be embeddings, feature vectors, and/or otherwise represented. The theme agent can include a classifier configured to classify the set of signals as one or more classes, wherein the top N classes can be associated with the set of signals (e.g., wherein N can be 1 or higher).

In a third variant, the theme agent can use a distance metric (e.g., cosine similarity, etc.) to identify clusters of signals within the signal set. This can be used to deduplicate the signals, to generate hypersignals from the signals, or otherwise used.

In a fourth variant, the theme agent can include a baseline model that determines whether a parameter of each signal deviates from a baseline value, then surface the signals with deviant parameters. Examples of parameters that can be monitored include: frequency, count, inclusion (e.g., binary determination of whether the signal is or is not within the set), and/or other parameters.

However, the theme agent can be otherwise configured.

The system can optionally include a context agent that functions to consolidate hypersignals and/or signals over time. This can be useful because the record agents and theme agents provide analysis (“insights”) for a given timestamp and can lack timeseries context. In examples, the context agent can re-edit the sub-themes and themes to fit into a larger historical or existing context. The context agent is specific to a single signal class, but can alternatively be shared across signal classes. The context agent can be specific to a hypersignal, or be generic across hypersignals. The context agent can include: a set of heuristics, a generative model, a neural network (e.g., CNN, DNN, RNN, etc.), a statistical model, and/or have any other suitable model architecture. In a first example, the context agent can track a hypersignal or signal's occurrence over time. In a second example, the context agent can evaluate which signal class has the highest variability in hypersignals. In a third example, the context agent can periodically generate summaries (e.g., in natural language) of hypersignals' time series. However, the context agent can be otherwise configured.

### 4. Method

As shown in FIG. 1, in variants, the data analysis method can include: receiving a set of data records from an entity S100; determining a set of summaries for each data record S200; determining a set of signals based on a batch of summaries across the set of data records S300; and determining a hypersignal based on the set of signals S400. The method functions to extract population-level signals (“hypersignals”, “themes”) from large volumes of data.

The method is performed using the system described above, but can alternatively be performed using any other system. The method can be: repeated each timestep, performed once, performed responsive to an event (e.g., entity call or request, receipt of an entity query), and/or at any other suitable time. All or portions of the method can be performed in real time (e.g., as the data is received, when a threshold corpus of data has been received, etc.), asynchronously, or otherwise performed. All or portions of the method can be performed automatically, manually, semi-automatically, and/or otherwise performed.

Receiving a set of data records from an entity S100 functions to obtain the data to extract signals from. In examples, the data records are received from the entity, but can additionally or alternatively be retrieved from a database or otherwise obtained. The data records can be received in real-time (e.g., streamed; received as the data is being generated; etc.), received as a batch, and/or otherwise received. The set of data records include data records from a single time window (e.g., automatically learned, manually determined, etc.), but can additionally or alternatively include data records from multiple time windows, include a threshold number of data records (e.g., determined based on the context limit of the summary model or record agent, etc.), and/or be otherwise related. The data records can be from a predetermined data stream (e.g., customer tickets, emails, texts, voicemails, call centers, etc.), from all data streams of the entity, and/or from any number of data streams. In an example, S100 can include receiving a stream of data records from an entity and batching data records from the stream into the set of data records. The set of data records can be persistently stored in the system, transiently stored (e.g., in RAM; wherein only the summary and downstream products can be stored; etc.), or otherwise stored.

S100 can optionally include processing the data record. In variants, this can include: embedding the data record into a shared space, converting the data record into a JSON representation, removing PII, identifying speakers, and/or otherwise processing the data record. The processed data record can be used in one or more of the subsequent processes (e.g., S200 through S400), or otherwise used.

S100 can optionally include filtering the data records, wherein only the set of filtered data records are used in subsequent processes (e.g., S200 through S400); alternatively, all data records are used. The data records can be filtered using importance functions or otherwise filtered. Importance functions can include, for example: rules or thresholds based on data record parameter values (e.g., filtering based on length, data record type, number of speakers, etc.); prompts to a filtering model (e.g., “identify the conversations that should be analyzed”); random selection; and/or otherwise constructed.

Determining a set of summaries for each data record S200 functions to summarize the data record, which can: reduce the number of tokens ingested by subsequent models; reduce noise (e.g., unimportant words or frames, etc.); increase the latency of downstream processing (e.g., by focusing imputation on a smaller set of data or concepts); enable use of smaller downstream models (e.g., smaller record agents and/or smaller theme agents that have smaller context limits); and/or confer other technical benefits. S200 is, in examples, performed in real-time, as the data records are received, but can additionally or alternatively be performed asynchronously (e.g., after a threshold number of new data records is received), and/or at any other suitable time. The summaries can be stored in association with: a data record identifier, a signal class identifier (e.g., associated with the prompt used to generate the summary), data record parameters (e.g., entity, data record timestamp(s), data record modality, etc.), and/or other information. Multiple summaries are determined for each data record (e.g., one for each signal class, one for each speaker, etc.); alternatively, a single summary can be determined for a data record. S200 includes providing the data record to a summary agent, wherein the summary agent summarizes the data record; alternatively, another model can summarize the data record.

In a first variant, S200 includes prompting the summary agent to summarize the data record, given the data record and a set of signal class-specific prompts. The set of signal class-specific prompts are for different signal classes, but can alternatively be for the same signal class. The prompts can be provided concurrently or serially. In this embodiment, S200 can output a summary for each signal-class-specific prompt; alternatively, S200 can output a single summary with the information requested by each prompt.

In a second variant, S200 includes querying the data record using a predetermined Q&A model (e.g., BERT), wherein the Q&A model includes a predetermined set of questions associated with one or more signal classes. A data record summary can be generated from the answers output by the model.

In a third variant, S200 includes decoding a summary from the data record. In this embodiment, the data record can be embedded into a latent space (e.g., semantic space), wherein the summary agent can include a decoder that decodes the data record into a shorter summary (e.g., in natural language). In this variant, different summary agents or decoders can be used to generate different summaries (e.g., for different signal classes).

However, the summaries can be otherwise determined.

Determining a set of signals based on a batch of summaries across the set of data records S300 functions to extract population-level analyses from multiple data records. S300 may be performed by a record agent but can be performed by other models. S300 may be generative, such that the signal search space is unconstrained to a predetermined set of signals (e.g., a user-specified set of signals), but can alternatively be discriminative or otherwise configured. For example, by leveraging generative models and a substantially unconstrained search space, S300 can “discover” previously unknown issues or unmonitored issues from customer conversations (e.g., detect a cold chain failure from a supplier's supplier). In variants, S300's latency can be reduced (e.g., such that S300 runs faster) by focusing the search space using a summary of the data record, wherein the summary includes relevant data record concepts, keywords, and other relevant features from the data record.

In variants, S300 can include: determining batches of summaries across the set of data records; and determining a set of signals from each batch. However, S300 can be otherwise performed.

Determining batches of summaries across the set of data records may include aggregating summaries that were determined from different data records, but can be otherwise performed. The summaries are related to the same signal class, but can alternatively be related to the same speaker, or share any other suitable set of parameters. The summaries' data records are from the same time window (e.g., a tumbling time window, sliding time window, etc.), associated with the same signal class (“insight stream”) or signal class prompt, and be received from the same entity, but can additionally or alternatively share other parameters (e.g., user geolocation, demographic, etc.).

Determining a set of signals from each batch can include extracting the signals from the summary batch using a record agent. In a first variant, determining the set of signals includes: providing the summary batch and a signal-extraction prompt to a record agent, wherein the record agent extracts signals from the batch of summaries. The batch of summaries is provided as a concatenated blob (e.g., text blob), such that the record agent has context about other summaries within the batch but can alternatively be serially provided to the record agent (e.g., wherein the record agent extracts signals from each individual summary) or otherwise provided to the record agent. In a second variant, the record agent can include a Q&A model, wherein determining the set of signals includes iteratively querying the summary batch, and generating signals (e.g., whether a queried concept or tag is within the batch) based on the query results. In a third variant, the record agent can include a classifier with different classification heads for each signal of interest, wherein the record agent classifies whether a signal of interest is present in the summary batch. However, the set of signals can be otherwise determined.

In variants, determining the set of signals is performed using a different record agent for each batch, wherein the record agent is associated with the same signal class as the prompt that generated the summaries within the batch; alternatively, the same record agent can be used to extract signals from different batches. For example, signals are extracted from customer intent summaries using customer intent record agents.

In variants, the set of signals can be determined using multiple record agents for a given batch. In these variants, the record agents can have different: model architectures, training data, providers (e.g., OpenAI™, Anthropic™, etc.), model versions (e.g., GPT3, GPT4o, Claude, etc.), sizes, hyperparameters (e.g., top p, top k, temperature, etc.), or otherwise differ.

In an illustrative example, four summaries related to customer intent, supply chain, shipping and handling, and pricing are extracted from each of a set of data records (e.g., customer conversations), wherein all customer intent summaries are aggregated into a customer intent batch, all supply chain summaries are aggregated into a supply chain batch, all shipping and handling summaries are aggregated into a shipping and handling batch, and all pricing summaries are aggregated into a pricing batch. In this example, all batches have the same number of summaries, but the summaries within the batch differ (e.g., due to the different prompts that were used to generate the summaries). Each batch can then be provided to a different set of record agents (e.g., the customer intent batch is provided to a set of customer intent agents, the supply chain batch is provided to a set of supply chain agents, the shipping and handling batch is provided to a set of shipping and handling agents, and the pricing batch is provided to a set of pricing agents), wherein the record agents within each set extract signals from the respective batches (e.g., customer intent signals, supply chain signals, S&H signals, pricing signals).

In variants, S300 can optionally include assigning one or more of the signals back to the data record (e.g., via the summary). For example, the record agent can output which summaries (or data record IDs) contributed the most to each signal, or output which summaries included the signal. The signal can then be assigned to the data records for the respective summaries. In variants, this can enable a user to pull up the data records contributing to a given signal or hypersignal.

However, S300 can be otherwise performed.

Determining a hypersignal based on the set of signals S400 functions to determine a consolidated set of population-level signals, to summarize the population-level signals, and/or otherwise reduce the noise in the signals generated in S300. In variants, the method can lack S400. S400 is performed by the theme agent, but can be performed by the record agent or by other models. The model is associated with the same signal class as the signal class prompt, summaries, and record agents, but can alternatively be associated with a different signal class. S400 is performed using signal sets associated with the signal class (e.g., signal sets generated from summaries associated with the signal class), but can be performed using other signal sets.

S400 can include: aggregating signal sets (e.g., output by related record agents), and determining a set of hypersignals from the aggregated signal sets.

In a first variation, determining a set of hypersignals from the aggregated signal sets includes prompting the theme agent to generate a set of hypersignals from the aggregated signal sets. In this variation, the aggregated signal sets can be concatenated into a blob (e.g., text blob) that is provided to the theme agent with the hypersignal prompt. The hypersignal prompt can be predetermined (e.g., associated with the signal class), received from a user (e.g., as a freeform query), or otherwise determined. Illustrative examples of hypersignal prompts can include: “Identify the most common topic”, “summarize why customers are churning”, or “what are the customers most upset about”. The aggregated signal sets include signals from a single time window, but can additionally or alternatively include signals from multiple time windows.

In a second variation, determining a set of hypersignals from the aggregated signal sets includes embedding the signals from the aggregated signal sets into a latent space (e.g., semantic space, contextual space, etc.), optionally clustering the embeddings (e.g., using a distance metric, such as cosine similarity), determining an aggregated signal from the embeddings (e.g., mean embedding, median embedding, most frequent embedding, etc.), and decoding the aggregated signal (e.g., using a decoder) to generate the hypersignals (e.g., for each cluster).

In a third variation, determining a set of hypersignals from the aggregated signal sets includes deduplicating the signals; identifying the top N signals (e.g., top N most frequent signals; top N signals with the highest confidence scores; etc.); and/or applying other heuristics to the aggregated signal set.

In a fourth variation, determining a set of hypersignals from the aggregated signal sets includes classifying the aggregated signal set as one or more hypersignals using a pretrained model.

In a fifth variation, determining a set of hypersignals can include using embeddings of the new signals, embeddings of historic signals (e.g., for the entity, from the same signal class, etc.) and a distance metric (e.g., cosine similarity) between the new and historic signals to identify emergent signals (e.g., emergent insights).

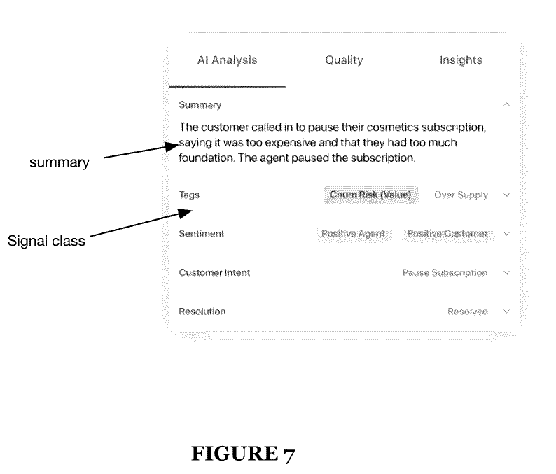

In a sixth variation, determining the set of hypersignals can include determining which signal class has signals over a threshold value, wherein those signal classes can be used as the hypersignals. Examples are shown in FIG. 5 and FIG. 7.

However, S400 can be otherwise performed.

The method can optionally include determining a timeseries analysis based on the set of signals S500. S500 can be repeated each time step, performed upon occurrence of an event (e.g., entity request), or performed at any other time. The timeseries analysis can be determined from: the signals, the hypersignals, and/or other data. The timeseries analysis is determined from signals from a single signal class but can additionally or alternatively be determined from signals from multiple signal classes. The timeseries analysis is determined using the context agent, but can be determined using other models (e.g., theme agent). In a first variant, the timeseries analysis is determined by prompting the context agent to output a timeseries analysis given the set of (hyper) signals. For example, the context agent can be prompted to detect anomalies in the timeseries of (hyper) signals (e.g., “were there any anomalous or new themes?”). In a second variant, the timeseries analysis can include a plot or chart of a signal set metric (e.g., a plot of each (hyper) signal's detection frequency). However, S500 can be otherwise performed.

The method can optionally include determining recommendations based on the set of signals S600. The recommendations can be determined based on signals, hypersignals, timeseries analyses, the source data records, the signal class, or other data. The recommendations can be provided to a user, such as an entity manager, an entity representative, or other user. The recommendations can be: predetermined recommendations (e.g., for the signal class) associated with a (hyper) signal; generated by a recommendation model (e.g., given the (hyper) signals, optionally given historical remediations for historical (hyper) signals; etc.); or otherwise determined.

However, the method can be otherwise performed.

All references cited herein are incorporated by reference in their entirety, except to the extent that the incorporated material is inconsistent with the express disclosure herein, in which case the language in this disclosure controls.

Optional elements in the figures are indicated in broken lines.

Different processes and/or elements discussed above can be defined, performed, and/or controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be manually defined, be custom instructions, be standardized instructions, and/or be otherwise defined. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

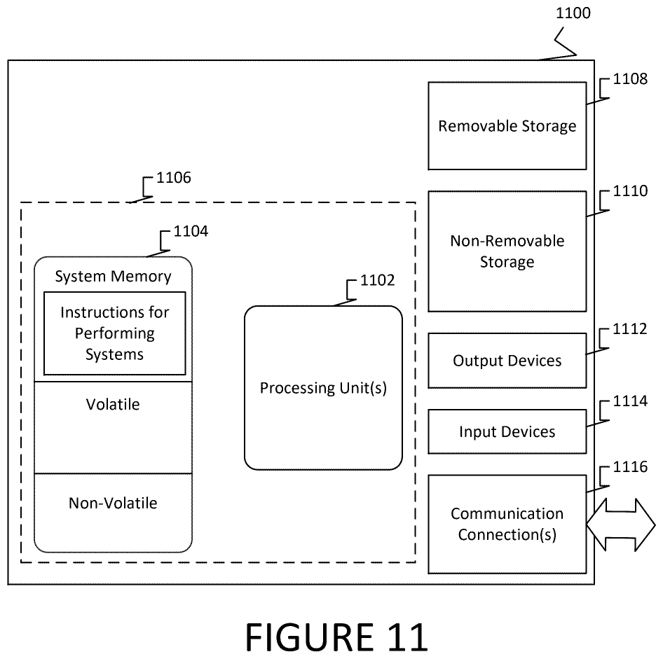

FIG. 11 and the associated descriptions provide a discussion of a variety of operating environments in which aspects of the disclosure may be practiced. However, the devices and systems illustrated and discussed with respect to FIG. 11 are for purposes of example and illustration and are not limiting of a vast number of computing device configurations that may be utilized for practicing aspects of the disclosure, described herein.

FIG. 11 illustrates a simplified block diagram of a device with which aspects of the present disclosure may be practiced in accordance with aspects of the present disclosure. The device may be a mobile computing device, for example. One or more of the present embodiments may be implemented in an operating environment 1100. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1100 typically includes at least one processing unit 1102 and memory 1104. Depending on the exact configuration and type of computing device, memory 1104 (e.g., instructions for generating a biometric hash as disclosed herein, etc.) may be volatile (such as RAM), non-volatile (such as ROM, flash memory, etc.), or some combination of the two. This most basic configuration is illustrated in FIG. 11 by dashed line 1106. Further, the operating environment 1100 may also include storage devices (removable, 1108, and/or non-removable, 1110) including, but not limited to, magnetic or optical disks or tape. Similarly, the operating environment 1100 may also have input device(s) 1114 such as remote controller, keyboard, mouse, pen, voice input, on-board sensors, etc. and/or output device(s) 1112 such as a display, speakers, printer, motors, etc. Also included in the environment may be one or more communication connections 1116, such as LAN, WAN, a near-field communications network, a cellular broadband network, point to point, etc.

Operating environment 1100 typically includes at least some form of computer readable media. Computer readable media can be any available media that can be accessed by the at least one processing unit 1102 or other devices comprising the operating environment. By way of example, and not limitation, computer readable media may comprise computer storage media and communication media. Computer storage media includes volatile and nonvolatile, removable and non-removable non-transitory media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1100 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Embodiments of the system and/or method can include every combination and permutation of the various elements (and/or variants thereof) discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

What is claimed is:

1. A method comprising:
receiving a set of data records;
generating a plurality of summaries for a plurality of data records from the set of data records, wherein the summary record is generated by generating a prompting a summary agent to summarize the at least the plurality of data records based a set of signal class-specific prompts;
generating a batch of summary data based upon the pluralities of summaries;
generating a set of signals using the batch of summary data; and
generating one or more hypersignals based upon the set of signals to reduce signal noise.

2. The method of claim 1, wherein the set of data records are received in real-time from a data stream.

3. The method of claim 1, further comprising, upon receiving the set of data records, preprocessing the data records by embedding one or more data records from the set of data records into a shared space.

4. The method of claim 1, further comprising, upon receiving the set of data records, preprocessing the data records by removing personally identifiable information (PII).

5. The method of claim 1, further comprising, upon receiving the set of data records, filtering the data records using one or more importance functions.

6. The method of claim 5, wherein the one or more importance functions comprise at least one of a set of rules or a threshold.

7. The method of claim 1, wherein generating the plurality of summaries comprises output a summary for each signal-class-specific prompt of the set of signal class-specific prompts.

8. The method of claim 1, wherein the plurality of data records are embedded into a semantic space.

9. The method of claim 8, wherein the summary agent comprises a decoder that decodes the plurality of data record into a natural language.

10. The method of claim 1, further comprising generating a timeseries analysis by prompting a context agent using the one or more hypersignals.

11. The method of claim 10, wherein the timeseries analysis detects anomalies in a timeseries of the one or more hypersignals.

12. The method of claim 1, further comprising generating a recommendation based upon at least one of the set of signals or the one or more hypersignals, wherein the recommendation is generated using a recommendation model.

13. A non-transitory computer storage medium encoding instruction that, when processed by one or more processors, cause the one or more processors to perform operations comprising:
receive a set of data records;
generate a plurality of summaries for a plurality of data records from the set of data records, wherein the summary record is generated by generating a prompting a summary agent to summarize the at least the plurality of data records based a set of signal class-specific prompts;
generate a batch of summary data based upon the pluralities of summaries;
generate a set of signals using the batch of summary data; and
generate one or more hypersignals based upon the set of signals to reduce signal noise.

14. The non-transitory computer storage medium of claim 13, further comprising instructions that cause the one or more processors to, upon receiving the set of data records, preprocess the data records by embedding one or more data records from the set of data records into a shared space.

15. The non-transitory computer storage medium of claim 13, further comprising instructions that cause the one or more processors to, upon receiving the set of data records, preprocess the data records by removing personally identifiable information (PII).

16. The non-transitory computer storage medium of claim 13, further comprising instructions that cause the one or more processors to generate a timeseries analysis by prompting a context agent using the one or more hypersignals.

17. The non-transitory computer storage medium of claim 13, further comprising instructions that cause the one or more processors to generate a recommendation based upon at least one of the set of signals or the one or more hypersignals, wherein the recommendation is generated using a recommendation model.

18. A system comprising:
at least one processor; and
memory encoding computer executable instructions that, when processed by the at least one processor, cause the at least one processor to perform operations comprising:
receive a set of data records;
generate a plurality of summaries for a plurality of data records from the set of data records, wherein the summary record is generated by generating a prompting a summary agent to summarize the at least the plurality of data records based a set of signal class-specific prompts;
generate a batch of summary data based upon the pluralities of summaries;
generate a set of signals using the batch of summary data; and
generate one or more hypersignals based upon the set of signals to reduce signal noise.

19. The system claim 18, further comprising computer executable instructions that cause the at least one processor to generate a timeseries analysis by prompting a context agent using the one or more hypersignals.

20. The system claim 18, further comprising computer executable instructions that cause the at least one processor to generate a recommendation based upon at least one of the set of signals or the one or more hypersignals, wherein the recommendation is generated using a recommendation model.
